(19) United States
(12) Patent Application Publication
(10) Pub. No.: US 2008/0005417 A1
(43) Pub. Date: Jan. 3, 2008

(54) METHOD FOR SPEEDY DELIVERY OF DATA BETWEEN PROCESSORS AND DIGITAL PROCESSING APPARATUS HAVING SHARED MEMORY

(75) Inventors: Byoungok Lee, Gyeonggi-do (KR); Jong Sik Jeong, Seoul (KR)

Correspondence Address: BLACKWELL SANDERS LLP, 720 OLIVE STREET, SUITE 2400, ST. LOUIS, MO, 63101, US

(73) Assignee: MTEKVISION CO., LTD., Seoul (KR)

(21) Appl. No.: 11/424,631

(22) Filed: Jun. 16, 2006

(51) Int. Cl. G06F 13/38

(52) U.S. Cl. 710/62; 711/149

(57) ABSTRACT

The present invention is directed to a method for speedy delivery of data between a plurality of processors and a digital processing apparatus having a shared memory. According to a preferred embodiment of the present invention, a memory unit having a plurality of partitioned areas can send access status information of a particular control unit for a partitioned storage area to each control unit to prevent overlapped access. When a first control unit writes data in a first partitioned storage area and then changes its access to a second partitioned area, a second control unit accesses the first partitioned storage area to read the data. According to the present invention, the process of communicating data through a BUS when delivering data between a plurality of processors is not needed, thereby enabling speedy delivery of data.

### BACKGROUND OF INVENTION

The present invention is directed to a digital processing apparatus, more specifically to a digital processing apparatus having a plurality of processors.

A portable terminal refers to a compact electronic device that is designed to be easily carried by a user in order to perform functions such as game or mobile communication. A portable terminal can be a mobile communication terminal, a personal digital assistant (PDA), or a portable multimedia player (PMP).

A mobile communication terminal generally refers to a device designed to allow a mobile user to telecommunicate with a remotely-located receiver. Through technological developments, however, the latest mobile communication terminals are equipped with extra features, such as camera and multimedia data playback, to the essential functions of mobile communication, short message communication, and address book.

FIG. 1 shows a block diagram of a conventional mobile communication terminal having a camera function.

Referring to FIG. 1, the mobile communication terminal 100 having a camera function comprises a high frequency processing unit 110, an A/D conversion unit 115, a D/A conversion unit 120, a control unit 125, a power supply 130, a key input 135, a main memory 140, a display 145, a camera 150, an image processing unit 155, and a support memory 160. The high frequency processing unit 110 processes a high frequency signal, which is transmitted or received through an antenna. The A/D conversion unit 115 converts an analog signal, outputted from the high frequency processing unit 110, to a digital signal and sends to the control unit 125. The D/A conversion unit 120 converts a digital signal, outputted from the control unit 125, to an analog signal and sends to the high frequency processing unit 110. The control unit 125 controls the general operation of the mobile communication terminal 100. The control unit 125 can comprise a central processing unit (CPU) or a micro-controller. The power supply 130 supplies electric power required for operating the mobile communication terminal 100. The power supply 130 can be coupled to, for example, an external power source or a battery. The key input 135 generates key data for, for example, setting various functions or dialing of the mobile communication terminal 100 and sends to the control unit 125. The main memory 140 stores an operating system and a variety of data of the mobile communication terminal 100. The main memory 140 can be, for example, a flash memory or an EEPROM (Electrically Erasable Programmable Read Only Memory). The display 145 displays the operation status of the mobile communication terminal 100 and an external image photographed by the camera 150. The camera 150 photographs an external image (a photographic subject), and the image processing unit 155 processes the external image photographed by the camera 150. The image processing unit 155 can perform functions such as color interpolation, gamma correction, image quality correction, and JPEG encoding. The support memory 160 stores the external image processed by the image processing unit 155.

As described above, the mobile communication terminal 100 having a camera function is equipped with a plurality of processors (that is, a main control unit and one or more supplementary control unit for performing additional functions). In other words, as shown in FIG. 1, the control unit 125 for controlling general functions of the mobile communication terminal 100 and the image processing unit 155 for controlling the camera function are included. Moreover, each processor is structured to be coupled with an independent memory. The supplementary control unit can take different forms depending on the kinds of additional functions, with which the portable terminal is equipped. For example, the supplementary control unit for controlling the camera function can process functions such as JPEG encoding and JPEG decoding; the supplementary control unit for controlling the movie file playback function can process functions such as video file (e.g., MPEG4, DIVX, H.264) encoding and decoding; and the supplementary control unit for controlling the music file playback function can process functions such as audio file encoding and decoding. Of course, there can be a supplementary control unit that can process various aforementioned functions altogether. Each of these control units has an individual memory for storing the data processed by the control unit. Therefore, according to the prior art, it is necessary to increase the number of control units and memories as portable terminals become increasingly multifunctional.

FIG. 2 illustrates an example of a coupling structure among a main control unit, a supplementary control unit, their corresponding memories, and a display device in accordance with the conventional art.

Referring to FIG. 2, the main control unit 210 and the supplementary control unit 220 communicate information through BUS1; the main control unit 210 is coupled with the main memory 230 through BUS2; and the supplementary control unit 220 is coupled to the supplementary memory 240 through BUS3. Moreover, the supplementary control unit 220 is coupled to the display device 250, which displays information corresponding to the instruction of the main control unit 210. A bus refers to a common-purpose electric pathway that is used to transmit information between the control unit, the main memory, and the input/output in a device such as a computer. A bus comprises a line for data, designating the address of each device or the location of the memory, and a line for distinguishing a variety of data transmission operation to be processed.

As illustrated in FIG. 2, each control unit 210, 220 is independently coupled with each memory 230, 240. Therefore, the main control unit 210 reads the data stored in the main memory 230 and transmits the data to the supplementary control unit 220 through a host interface or reads the data stored in the supplementary memory 240 by requesting the supplementary control unit 220. In other words, in case certain data is processed in the main control unit 210 and the supplementary control unit 221, respectively, the main control unit 210 accesses the main memory 230 to perform a necessary process and then transmits the processed data to the supplementary control unit 220, and the supplementary control unit 220 re-processes the received data and stores in the supplementary memory 240. Then, the supplementary control unit 220 transmits the data stored in the supplementary memory 240 back to the main control unit 210 to have it stored in the main memory 230.

In this case, the larger the amount of data, communicated between the main control unit 210 and the supplementary control unit 220, is, the more time each control unit 210, 220 spends on the operation (i.e. memory access, host interface operation) requested by the other control unit rather than the operation requested by its own processor. For example, in case data-heavy 3D graphic data is processed and displayed on the display device 250, the main control unit 210 reads and processes the data stored in the main memory 230, and transmits the data to the supplementary control unit 220, and the supplementary control unit 220 stores the data (e.g. polygon data, texture data) received through BUS1 in the supplementary memory 240, then reads, processes and displays on the display device 250.

In a case such as this kind of 3D graphic data process, it is inevitable that a large amount of data is communicated between the main control unit 210 and the supplementary control unit 220. Subsequently, while communicating the large amount of data, time is unnecessarily wasted and the process efficiency of each control unit 210, 220 is wasted.

Moreover, an increasing number of functions performed by a portable terminal and an increasing amount of data to be processed by linking a plurality of processors increase lead to a bottleneck problem in data communication. As a result, the problems described above weaken the overall performance of a multi-function portable terminal.

Architecture with shared memory is disclosed in PCT Patent Publication No. WO 03/085524 published Oct. 16, 2003. This patent application discloses a method of sharing a memory module between a plurality of processors. The method comprises dividing the memory module into n banks, where n=at least 2, wherein each bank can be accessed by one or more processors at any one time; mapping the memory module to allocate sequential addresses to alternate banks of the memory; and storing data bytes in memory, wherein said data bytes in sequential addresses are stored in alternate banks due to the mapping of the memory. According to this prior art reference, it determines whether memory access conflict has occurred. When access conflict occurs, it locks processors with lower priorities for one or more cycles. However the prior art reference does not teach or suggest the method of the present invention. The prior art reference only discloses a method of sharing memory banks by multiple processors which operate independently. According to the prior art reference, each processor still requires its own bus coupled to the memory unit for transmitting data to the memory unit.

There is thus a need for a method for speedy delivery of data between processors and a memory unit wherein a main control unit is operatively coupled to a supplementary control unit through a bus (Host Interface) to share the memory areas. The present invention provides an advance in the art by providing a method for speedy delivery of data between a plurality of processors and a digital processing apparatus having a shared memory that can minimize the data transmission time between control units by partitioning the storage area of the shared memory into a plurality of partitioned areas and allowing a plurality of control units to access each partitioned area.

Further objectives and advantages of the present invention will become apparent from a careful reading of a detailed description provided hereinbelow, with appropriate reference to the accompanying drawings.

### SUMMARY OF INVENTION

In order to solve the problems described above, it is an object of the present invention to provide a method for speedy delivery of data between a plurality of processors and a digital processing apparatus having a shared memory that can minimize the data transmission time between control units by partitioning the storage area of the shared memory into a plurality of partitioned areas and allowing a plurality of control units to access each partitioned area.

It is another object of the present invention to provide a method for speedy delivery of data between a plurality of processors and a digital processing apparatus having a shared memory that can allow each control unit to handle its dedicated process to optimize the operation speed and efficiency of each control unit by allowing partitioned storage areas of the shared memory to be accessed by a plurality of control units.

It is yet another object of the present invention to provide a method for speedy delivery of data between a plurality of processors and a digital processing apparatus having a shared memory that only require a transfer of access authority to immediately deliver data by allowing partitioned storage areas of the shared memory to be cross-accessed by a plurality of control units.

It is still another object of the present invention to provide a method for speedy delivery of data between a plurality of processors and a digital processing apparatus having a shared memory that can simplify the control sequence of each control unit by having the shared memory generate and output status information (i.e. occupation status information) on partitioned storage areas.

It is still another object of the present invention to provide a method for speedy delivery of data between a plurality of processors and a digital processing apparatus having a shared memory that can maximize the data delivery speed by having the main control unit sequentially write data in the partitioned storage areas of the shared memory and the supplementary control unit access the storage areas, in which the data is written by the main memory, and read the data in sequence.

Other objects of the present invention will be apparent with reference to preferred embodiments described below.

In order to achieve the above objects, an aspect of the present invention features a digital processing apparatus having a memory shared by a plurality of control units.

According to a preferred embodiment of the present invention, the digital processing apparatus has an output device, a memory unit, a supplementary control unit, and a main control unit. The memory unit consists of partitioned storage areas in a quantity of m (a natural number between 2 and n (a natural number of larger than 2)). The supplementary control unit is coupled to the memory unit through a first bus and reads raw data, which is written in a partitioned storage area accessed through the first bus, processes the raw data in accordance with a process order, and then outputs the processed raw data through the output device. The main control unit is coupled to the supplementary control unit through a second bus and transmits the process order to the supplementary control unit through the second bus. The main control unit is coupled to the memory unit through a third bus and writes the raw data in the partitioned storage area. The memory unit generates access status information of the supplementary control unit or the main control unit on the partitioned storage area and transmits the access status information to at least one of the supplementary control unit and the main control unit.

The supplementary control unit accesses a partitioned storage area, in which the main control unit released access after writing the raw data, by referencing the access status information and reads the raw data.

The memory unit can comprise a first port for transmitting and receiving a control signal and the raw data to and from the supplementary control unit through the first bus and a second port for transmitting and receiving a control signal and the raw data to and from the main control unit through the third bus.

In the digital processing apparatus, the supplementary control unit and the main control unit are controlled by the access status information not to access the same partitioned storage area at the same time.

Area partition information corresponding to the size or quantity of the partition storage areas can be set by a first control unit, which is one of the main control unit and the supplementary control unit, and can be delivered to a second control unit, which is the other of the main control unit and the supplementary control unit.

The access status information can be about the writable status and readable status corresponding to the partitioned storage area.

In order to achieve the above objects, another aspect of the present invention features a recorded medium recording a program. In the program, a plurality of control units exchange the access authority for a partitioned area consisted in a memory to execute a real-time delivery of data.

According to a preferred embodiment of the present invention, the recorded medium tangibly embodies a program of instructions executable by a digital processing apparatus to execute a method for delivering data between a plurality of control units using one memory unit. The program is readable by the digital processing apparatus. The recorded medium can executing the steps of: (a) a memory unit generating first access status information and providing the first access status information to a first control unit and a second control unit through a first bus and a second bus, the memory unit consisting of partitioned storage areas, the partitioned storage areas being a quantity of m (a natural number between 2 and n (a natural number of larger than 2)); (b) the first control unit transmitting a process order to the second control unit through a third bus, the process order corresponding to raw data; (c) the memory unit delivering second access status information to the second control unit if the first control unit accesses a first partitioned storage area through the first bus by referencing the first access status information and starts writing the raw data, the second access status information indicating that the first partitioned storage area is accessed by the first control unit; (d) the memory unit delivering third access status information to the second control unit if the first control unit terminates access to the first partitioned storage area, the third access status information indicating that the first partitioned storage area is accessible; (e) the memory unit delivering fourth access status information to the first control unit if the second control unit accesses a first partitioned storage area through the second bus by referencing the third access status information and starts reading the raw data, the fourth access status information indicating that the first partitioned storage area is accessed by the second control unit; and (f) the second control unit processing the read raw data in accordance with the process order.

The recorded medium can further execute the step of having the second control unit outputted through an output device coupled with the processed raw data.

The step (f) can comprise the steps of: the second control unit processing the read raw data in accordance with the process order); the second control unit determining whether the second control unit has completed reading raw data written in the first partitioned storage area; and the second control unit terminating the access to the first partitioned storage area if the second control unit has completed reading the raw data.

The step (d) can further comprise the steps of: the first control unit determining whether the storage space of the first partitioned storage area is used up; if used up, the first control unit terminating access to the first partitioned storage area; the memory unit generating the third access status information, which comprises information indicating that the first partitioned storage area is accessible and information on whether the second partitioned storage area is accessible, and delivering to the first control unit and the second control unit; the first control unit accessing the second partitioned storage area through the first bus and writing the raw data continuously if it is determined by referencing the third access status information that the second storage area is accessible; and the memory unit generating fifth access status information, which indicates that the second partitioned storage area is accessed by the first control unit, and delivering the fifth access status information to the second control unit.

The above step (f) can comprise the steps of: the second control unit processing the read raw data in accordance with the process order; the second control unit determining whether the second control unit has completed reading raw data, the raw data having been written in the first partitioned storage area; the second control unit terminating access to the first partitioned storage area if the second control unit has completed reading the raw data; the memory unit delivering sixth access status information to the first control unit, the sixth access status information indicating that the first partitioned storage area is accessible; the second control unit determining whether seventh access status information is received from the memory unit, the seventh access status information indicating that the second partitioned storage area is accessible; and the second control unit accessing the second partitioned storage area and reading the raw data continuously if the seventh access status information is received.

### BRIEF DESCRIPTION OF DRAWINGS

These and other features, aspects, and advantages of the present invention will become better understood with regard to the following description, appended claims, and accompanying drawings where:

FIG. 1 shows a block diagram of a conventional mobile communication terminal having a camera function;

FIG. 2 shows a block diagram of an example of a conventional coupling structure between a main control unit, a supplementary control unit, each memory, and a display device;

FIG. 3 shows a block diagram of a coupling structure between a main control unit, a supplementary control unit, a memory unit, and a display device in accordance with a preferred embodiment of the present invention;

FIG. 4 shows partition of the storage area of the memory unit in accordance with a preferred embodiment of the present invention; and

FIG. 5 shows a flowchart for control units sequentially accessing and processing according to an access authority control on the partitioned storage area in accordance with a preferred embodiment of the present invention.

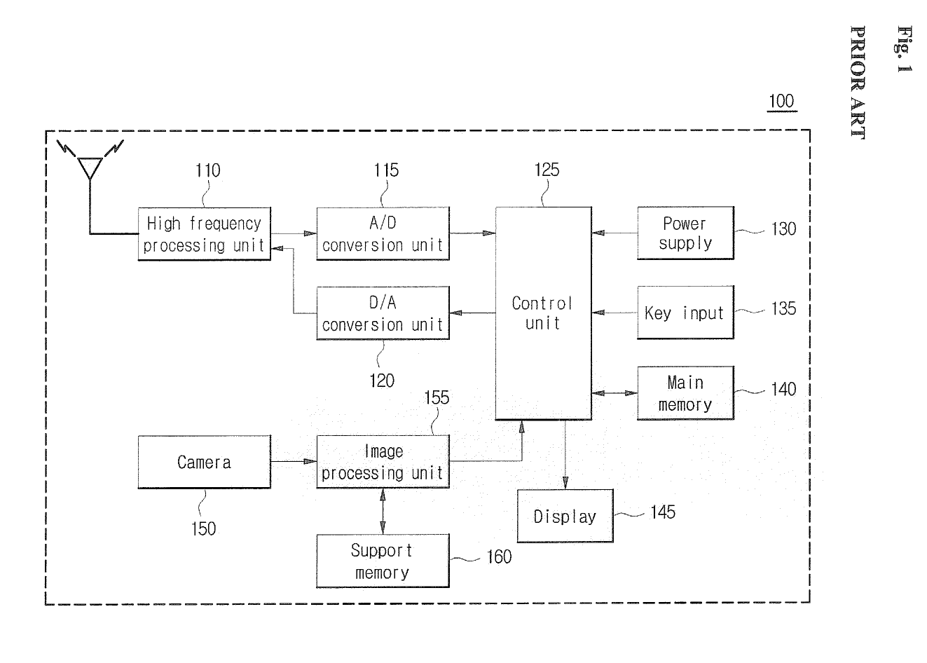

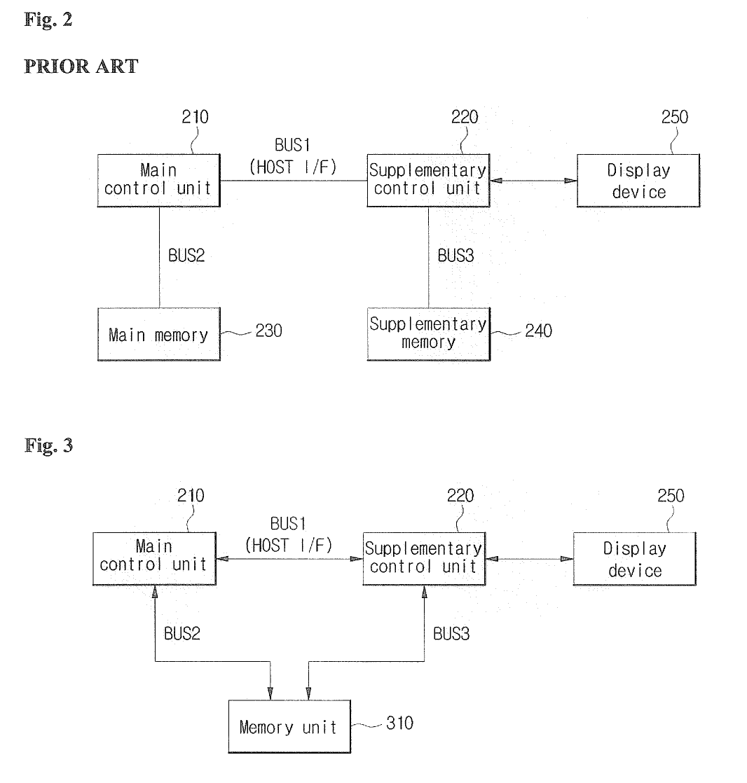

It should be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. It should be understood, of course, that the invention is not necessarily limited to the particular embodiments illustrated herein. Like numbers utilized throughout the various Figures designate like or similar parts or structure.

### DETAILED DESCRIPTION

Hereinafter, preferred embodiments of the present invention shall be described in detail with reference to the accompanying drawings. To aid overall understanding of the present invention, the same reference numbers shall be assigned to the same means, regardless of the figure number. Moreover, the numbers (e.g., bus #1, bus #2, A, B, etc.) are only used in the description to identify identical or similar elements.

Described herein is only a process of the memory unit controlling the access authority such that the main control unit writes data to be processed by a supplementary control unit in a specific storage area and then the pertinent supplementary control unit accesses the pertinent storage area to read the data. However, a person of ordinary skill in the art shall be able to understand that the memory unit can also control the access authority in such a way that any first control unit (e.g. the main control unit or a first supplementary control unit) writes data to be processed by a second control unit (e.g. a second supplementary control unit or the main control unit) in a specific storage area and then the second control unit accesses the pertinent storage area to read the data. Therefore, it should be understood that additional description of what a person of ordinary skill in the art can easily understand will not be provided herein and that the spirit and scope of the present invention will not be restricted by the description herein.

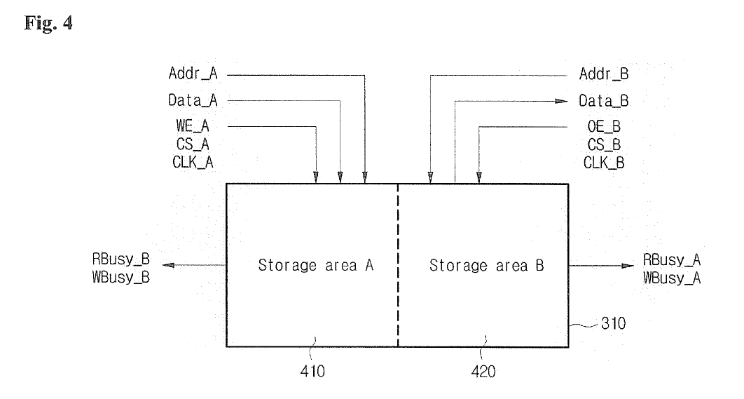

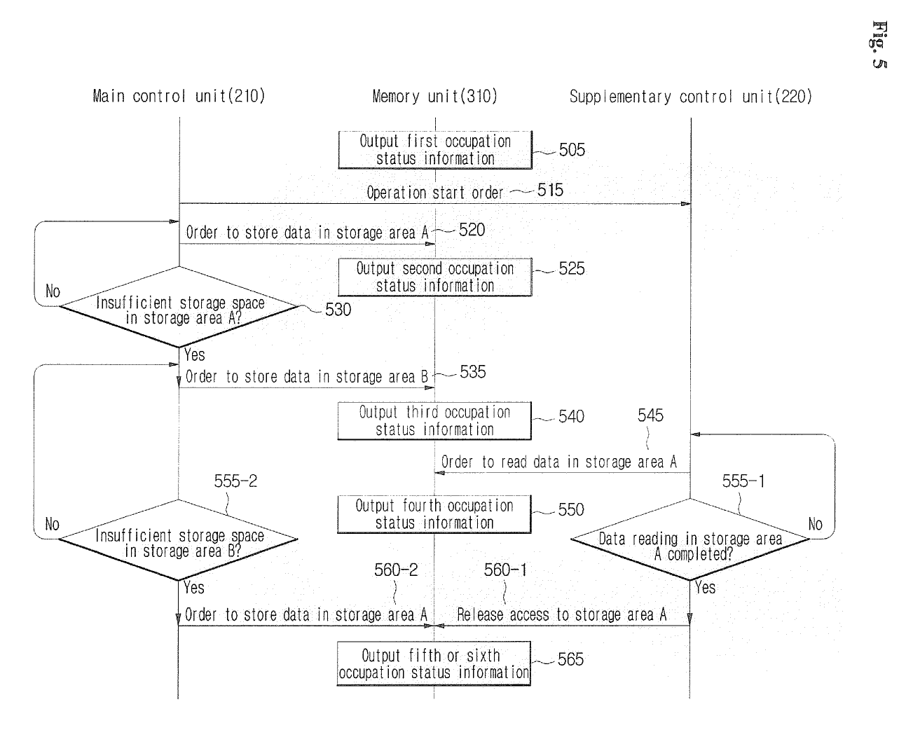

FIG. 3 is a block diagram showing a coupling structure between the main control unit, the supplementary control unit, the memory unit, and the display device in accordance with a preferred embodiment of the present invention, and FIG. 4 shows partition of the storage area of the memory unit in accordance with a preferred embodiment of the present invention.

Referring to FIG. 3, a digital processing apparatus in accordance with the present invention has a structure in which the main control unit 210 and the supplementary control unit 220 share a single memory unit 310. The display device 250, which is either controlled directly by the main control unit 210 or by the supplementary control unit 220 corresponding to a process order of the main control unit 210, is coupled in the back of the supplementary control unit 220. Of course, there can be a variety of coupled output devices depending on the function of the supplementary control unit 220. Moreover, although FIG. 3 shows one supplementary control unit 220 only, it should be evident that the number of supplementary control units and the process operation thereof can vary in accordance with the functions of the digital processing apparatus.

As shown in FIG. 3, the main control unit 210 and the supplementary control unit 220 communicate information (e.g. order to start operating the display device 250, order to stop operating the display device 250, and status information) through BUS1. The main control unit 210 is coupled to the memory unit 310 through BUS2 and writes data (e.g. polygon data, texture data) in a particular storage area of the memory unit 310. The supplementary control unit 220 is coupled to the memory unit through BUS3 and reads the data written by the main control unit 210 in the particular storage area of the memory unit 310. A bus or BUS refers to a common-purpose electric pathway that is used to transmit and receive information between the control unit, the main memory, and the input/output in a device such as a computer. Here, the main control unit 210 can be a processor that controls the general operation of a digital processing apparatus (e.g. a portable terminal). Also, the supplementary control unit 220 can be a dedicated processor for processing the MPEG4, 3-D graphic, camera, and/or MP3 file playback functions. A peripheral device such as the display device 250 can be coupled to the back of the supplementary unit 220.

The memory unit 310 is shared by the plurality of coupled control units (i.e. the main control unit 210 and one or more supplementary control units), and has the number of access ports corresponding to the number of control units that are encompassed therein or sharing the memory unit 310. For example, if the memory unit 310 shares the main control unit 210 and the supplementary control unit 220, as shown in FIGS. 3 and 4, the two control units 210, 220 use one memory unit 310, and thus the memory unit 310 encompasses 2 access ports. That is, the two access ports are identified as a first port and a second port, which are connected to the main control unit 210 and the supplementary control unit 220, respectively. In other words, although there is one memory core in the memory unit 310, there can be a plurality of access ports. It is also possible that each of the main control unit 210 and the supplementary control unit 220 uses an independent clock.

The storage area of the memory unit 310 can be partitioned to a plurality of areas, and the number of storage areas can be from 2 to N (a natural number). For example, the number of partitioned storage areas can be the same as the number of encompassed control units. This is to allow each control unit to individually access each partitioned area through an independent route at the same time to perform a necessary operation (e.g. writing data or reading data) without interference or collision with the other control unit. For example, if there are two control units coupled to the memory unit 310, as shown in FIG. 4, the memory unit 310 can be partitioned to two areas (i.e. a first storage area 410 and a second storage area 420). Each of the partitioned areas 410, 420 can be accessed individually as long as it is not assigned to a particular control unit and both areas are not accessed at the same time. This is to continuously maintain the temporal consistency of data by having the process on one side complete before the next process starts. Of course, the storage area of the memory unit 310 can be partitioned into more than 2 areas although there are 2 control units coupled to the memory unit 310.

The process of inputting and outputting a signal, illustrated in FIG. 4, is as follows: In case the main control unit 210 is to write particular data in storage area A of the partitioned areas of the memory unit 310, the main control unit 210 sends to the memory unit 310 address information (Addr_A, i.e. the address signal of storage area A) for writing the data, data to be written (Data_A), and control signals (e.g. WE_A (Write Enable) for instructing storage area A to write data, CS_A (Chip Select_A) for storage area A, and CLK_A (clock)). The memory unit 310 has the data being received be written in storage area A according to an order (i.e. an order to write) of the main control unit 210. The main control unit 210 terminates the access to storage area A if the storage capacity of storage A is used up by the predetermined address information for the partitioned area and the address information instructed while writing data, and the memory unit 310 provides occupation status information (e.g. information disclosing that the access to storage area A is terminated and storage area B is now accessible for writing data) to the control units. Moreover, the main control unit 210 terminates the access to the memory unit 310 if writing data is completed before the storage capacity of storage area A is used up, in which case the memory unit 310 provides the occupation status information, which is updated, to the control units.

Once data is written in storage area A through the process described above, the supplementary control unit 220, which intends to read and use the data, transmits address information (Addr_A, which is the address signal of storage area A) for reading the data and control signals (e.g. OE_A (output enable) signal to instruct the reading of data in storage area A, a chip select signal (CS_A, i.e. Chip Select_A) for storage area A, and a clock (CLK_A) signal) to read the data (Data_A). Whether the supplementary control unit 220 can access storage area A can be verified by using the occupation status information provided by the memory unit 310. For example, if “R Busy_A” in the occupation status information provided by the memory unit 310 is a first state (e.g. “Low State”), it can be recognized that storage area A is accessible and readable. The process of the first control unit writing data in a storage area of the memory unit 310 and the second control unit accessing the storage area and reading the written data after the first control unit finishes writing the data will be described later with reference to FIG. 5.

The size of partitioned areas, that is, the first storage area 410 and the second storage area 420, of the memory unit 310 can be predetermined as a default, partitioned to a size by the main control unit 210 and/or the supplementary control unit 220, or varied by the main control unit 210 and/or the supplementary control unit whenever necessary (e.g. data to be written is larger than the capacity of the writable area). In other words, of the entire storage area of the memory unit 310, the address information for the partitioned storage area can be set and managed by the main control unit 210, and the address information set by the main control unit 210 can be provided and shared by the supplementary control unit 220. Of course, the address information can be also set and managed by the supplementary control unit 220, and, when necessary, each control unit can have an authority to set the address information to provide the set address information to the other control unit to share the address information. In this case, information on the partitioned areas of the memory unit 310 can be recognized by each control unit while the digital processing apparatus (e.g. a portable terminal) is booted. Further, if the memory unit 310 is of an SDRAM, the storage area can be partitioned in units of bank. That is, a typical SDRAM comprises an RAS address, a CAS address, and a Bank address, and it is common that there are 4 banks. Here, the 4 banks can be grouped in two, and each group can be assigned as the first storage area 410 and the second storage area 420, respectively.

FIG. 5 a flowchart showing the control units sequentially accessing and processing according to an access authority control on the partitioned storage area in accordance with a preferred embodiment of the present invention.

In describing the process of sequentially accessing and processing by the control units, with reference to FIG. 5, it is assumed that the initial state of every partitioned storage area (assumed to be partitioned to storage area A and storage area B only, hereinafter) of the memory unit 310 is writable (i.e. WBusy (Write Busy) is “low”) and readable (i.e. RBusy (Read Busy) is “low”), and the address size of each partitioned area is 1,000. It is also assumed that the main control unit 210 writes data in the order of storage area A, storage area B, and storage area A, and the supplementary control unit 220 reads the data, written by the main control unit 210, in the order of storage area A, storage area B, and storage area A.

Referring to FIG. 5, the memory unit 310 provides, in step 505, first occupation status information, which indicates that the initial state of every partitioned storage area is writable and readable, to each control unit.

When certain information (e.g. 3-D graphic) is to be outputted through a peripheral device (e.g. the display device 250), the main control unit 210 sends an operation start order, in step 515, through BUS1 (refer to FIG. 3) to the supplementary control unit 220 coupled to the peripheral device.

Then, the main control unit 210 sends a data store order, in step 520, through BUS2 (refer to FIG. 3) in order to write data in storage area A. As described above, the data store order can comprise data store address, data to be written, and control signals (e.g. WE_A, CS_A, and CLK_A).

Since the main control unit 210 is accessed to storage area A and writing data, the memory unit 310 provides, in step 525, a second occupation status information, indicating that storage area A is occupied by the main control unit 210 for writing data, to each control unit. The second occupation status information can comprise only the information (i.e. WBusy_A=High) that is changed from the previous occupation status information or the occupation status information (i.e. WBusy_A=High, RBusy_A=Low, WBusy_B=Low, RBusy_B=Low) for every partitioned area.

The supplementary control unit 220 accesses the memory unit 310 to read the data written by the main control unit 210 if it becomes possible to access the memory unit by the instruction of the operation start order of step 515 or to access the storage area in which the main control unit 210 writes data by use of the occupation status information provided by the memory unit 310. The supplementary control unit 220 can recognize in which partitioned storage area the main control unit 210 stores data with the changed status (i.e. change from WBusy_A=Low to WBusy_A=High) of the occupation status information only after receiving the operation start order.

In step 530, the main control unit 210 determines whether the storage space of storage area A is used up. The main control unit 210 can compare the size of the data storage address included in the data store order and the size of the data storage address pre-allocated in each partitioned storage area to determine if the storage space is used up. Of course, the memory unit 310 can provide information on whether the storage space in a partitioned storage area is used up. Moreover, if the main control unit 210 finished writing the data to be delivered to the supplementary control unit 220, the remaining steps of the main control unit 210 can be omitted.

If the storage space is used up, the process moves to step 535, but if there is storage space remaining, the process repeats step 520. In other words, the data store order can be repeatedly sent, so as to correspond to a new storage address and/or new data, until all data to be written is written or the storage space of storage area A is used up. However, the memory unit 310 maintains the occupation state of the main control unit 210 on storage area A until the main control unit 210, accessed to storage area A, releases the access state. Thus, it is not necessary that the memory unit 310 repeatedly outputs the occupation status information every time step 520 is repeated, and it is adequate that the current occupation status information is maintained.

Since the main control unit 210 recognizes that storage area B is writable (i.e. WBusy=Low) through the second occupation status information provided in step 525, the main control unit 210 sends a data store order to the memory unit 310 through BUS2 (refer to FIG. 3) in step 535 in order to write remaining data in storage area B. Of course, if storage area B is accessed by another supplementary control unit, the main control unit 210 stands by until the access by the supplementary control unit is released.

In step 540, the memory unit 310 provides third occupation status information to each control unit. The third occupation status information indicates that the main control unit 210 has released the access to storage area A and accessed storage area B to write data. As described earlier, the third occupation status information can also comprise only the information (i.e. WBusy_A=Low, WBusy_A=High) that is changed from the previous occupation status information or the occupation status information (i.e. WBusy_A=Low, RBusy_A=Low, WBusy_B=High, RBusy_B=Low) for every partitioned area.

The supplementary control unit 220 recognizes that the access by the main control unit 210 to storage area A has been released by the third occupation status information (and the second occupation status information) and is now readable (i.e. RBusy_A=Low), and sends an order to read the data written in storage area A. As described above, the data read order can comprise data store address and control signals (e.g. OE_A, CS_A, and CLK_A).

In step 550, the memory unit 310 provides fourth occupation status information to each control unit. The fourth occupation status information indicates that the supplementary control unit 220 has accessed storage area A in order to read data. As described earlier, the fourth occupation status information can also comprise only the information (i.e. RBusy_A=High) that is changed from the previous occupation status information or the occupation status information (i.e. WBusy_A=Low, RBusy_A=High, WBusy_B=High, RBusy_B=Low) for every partitioned area.

In step 555-1, the supplementary control unit 220 determines whether the reading of data written in storage area A is completed. The completion of reading of the stored data can be determined by comparing the size of the data store address included in the data read order and the size of the data store address pre-allocated in each partitioned storage area.

If the reading of the data written in storage area A is not completed, step 545 is performed to continue reading the data. In this case also, step 550 can be skipped. However, if the reading of the data written in storage area A is completed, the supplementary control unit 220 releases the access to storage area A in step 560-1.

In step 565, the memory unit 310 provides a fifth occupation status information to each control unit. The fifth occupation status information indicates that the supplementary control unit 220 has released its access to storage area A. As described earlier, the fifth occupation status information can also comprise only the information (i.e. RBusy_A=Low) that is changed from the previous occupation status information or the occupation status information (i.e. WBusy_A=Low, RBusy_A=Low, WBusy_B=High, RBusy_B=Low) for every partitioned area. Then, the supplementary control unit 220 stands by until storage area B is accessible (i.e. until the main control unit 210 terminates writing data in storage area B and releases the access) for reading the data.

In a separate process of step 555-2, the main control unit 210 determines whether the storage space of storage area B is used up. The main control unit 210 can compare the size of the data storage address included in the data store order and the size of the data storage address pre-allocated in each partitioned storage area to determine if the storage space is used up. Of course, the memory unit 310 can provide information on whether the storage space in a partitioned storage area is used up. Moreover, if the main control unit 210 finished writing the data to be delivered to the supplementary control unit 220, the remaining steps of the main control unit 210 can be omitted.

If the storage space is used up, a data store order, for writing data again in storage area A, is sent to the memory unit 310 in step 560-2, but step 535 is repeated if there is storage space remaining in storage area B. In this case also, step 540 can be skipped, as described earlier. The data stored in storage area A through step 560-2 can overwrite the data stored through step 520 or can be written after deleting existing data. However, if the supplementary control unit 220 is still reading data in storage area A, step 560-2 can be performed after the supplementary control unit 220 terminates the access.

In step 565, the memory unit 310 provides a sixth occupation status information to each control unit. The sixth occupation status information indicates that the main control unit 210 has released its access to storage area B and accessed storage area A again. As described earlier, the sixth occupation status information can also comprise only the information (i.e. WBusy_A=Low, WBusy_B=High) that is changed from the previous occupation status information or the occupation status information for every partitioned area.

As illustrated in FIG. 5, the main control unit 210, accessed to storage area B, writes data while the supplementary control unit 220, accessed to storage area A, reads data. Although FIG. 5 shows as if the main control unit 210 and the supplementary control unit 220 perform steps 555-1 through 565 at the same time, it should be evident that these steps can be reorganized in time series in accordance with the process capability of each control unit or the difficulty of each process operation. In other words, the process by each control unit is a separate, individual operation. That is, in case the main control unit 210, which writes data in storage area B, uses up the storage space of storage area B, the main control unit 210 determines, by use of the fifth occupation status information, whether storage area A is accessed by any supplementary control unit and then writes data by accessing storage area A again if storage area A is accessible. Separately from this, in case all of the data is read, the supplementary control unit 220, which reads data written in storage area A, determines, by use of the sixth occupation status information, whether storage area B is accessible (i.e. whether the main control unit 210 or any other supplementary control unit is accessed) and then reads data by accessing storage area B if storage area B is accessible.

Through the steps describe above, the main control unit 210 does not have to deliver the data to be processed in the supplementary control unit 220 through BUS1. Rather, the main control unit 210 can store the data in any storage area and terminate the access, and can have the supplementary control unit 220 access the storage area. Thus, data can be quickly delivered by simply changing the subject that is accessing the storage area.

As described above, the method for speedy delivery of data between a plurality of processors and the digital processing apparatus having a shared memory can minimize the data transmission time between control units by partitioning the storage area of the shared memory into a plurality of partitioned areas and allowing a plurality of control units to access each partitioned area.

The present invention can also allow each control unit to handle its dedicated process to optimize the operation speed and efficiency of each control unit by allowing partitioned storage areas of the shared memory to be accessed by a plurality of control units.

Further, the present invention only requires a transfer of access authority to immediately deliver data by allowing partitioned storage areas of the shared memory to be cross-accessed by a plurality of control units.

Moreover, the present invention can simplify the control sequence of each control unit by having the shared memory generate and output status information (i.e. occupation status information) on partitioned storage areas.

Furthermore, the present invention can maximize the data delivery speed by having the main control unit sequentially write data in the partitioned storage areas of the shared memory and the supplementary control unit access the storage areas, in which the data is written by the main memory, and read the data in sequence.

Although a certain preferred embodiment of the present invention has been described, anyone of ordinary skill in the art to which the invention pertains should be able to understand that a large number of modifications and permutations are possible within the spirit and scope of the invention, which shall only be defined by the claims, appended below.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A digital processing apparatus, comprising:
an output device coupled to at least one control unit;
a memory unit having a plurality of partitioned storage areas;
a supplementary control unit, the supplementary control unit being coupled to said memory unit through a first bus, the supplementary control unit reading raw data written in a partitioned storage area of said memory unit, the partitioned storage area being accessed through said first bus, the raw data being processed in accordance with process order, the raw data being outputted through said output device; and
a main control unit, the main control unit being coupled to said supplementary control unit through a second bus and transmitting said process order to said supplementary control unit through said second bus, the main control unit being coupled to said memory unit through a third bus and writing said raw data in said partitioned storage area,
wherein said memory unit generates access status information of said supplementary control unit or said main control unit on said partitioned storage area and transmits said access status information to at least one of said supplementary control unit and said main control unit.

2. The digital processing apparatus of claim 1, wherein said supplementary control unit accesses a partitioned storage area by referencing said access status information and reads said raw data, said main control unit having released access to said partitioned area after writing said raw data in said partitioned area.

3. The digital processing apparatus of claim 1, wherein said memory unit comprises a first port for transmitting and receiving a control signal and said raw data to and from said supplementary control unit through said the first bus and a second port for transmitting and receiving a control signal and said raw data to and from said main control unit through said third bus.

4. The digital processing apparatus of claim 1, wherein said supplementary control unit and said main control unit are controlled by said access status information not to access the same partitioned storage area at the same time.

5. The digital processing apparatus of claim 1, wherein area partition information corresponding to the size or quantity of said partition storage areas is set by a first control unit which is one of said main control unit and said supplementary control unit and is delivered to a second control unit which is the other of said main control unit and said supplementary control unit.

6. The digital processing apparatus of claim 1, wherein said access status information comprises at least one of writable status and readable status corresponding to said partitioned storage area.

7. A method for delivering data between a plurality of control units using one memory unit, the method comprising the steps of:
(a) a memory unit generating first access status information and providing the first access status information to a first control unit and a second control unit through a first bus and a second bus, the memory unit having a plurality of partitioned storage areas;
(b) said first control unit transmitting a process order to said second control unit through a third bus, the process order corresponding to raw data;
(c) said memory unit delivering second access status information to said second control unit if said first control unit accesses a first partitioned storage area through said first bus by referencing said first access status information and starts writing said raw data, the second access status information indicating that said first partitioned storage area is accessed by said first control unit;
(d) said memory unit delivering third access status information to said second control unit if said first control unit terminates access to said first partitioned storage area, the third access status information indicating that said first partitioned storage area is accessible;
(e) said memory unit delivering fourth access status information to said first control unit if said second control unit accesses a first partitioned storage area through said second bus by referencing said third access status information and starts reading said raw data, the fourth access status information indicating that said first partitioned storage area is accessed by said second control unit; and
(f) said second control unit processing said read raw data in accordance with said process order.

8. The method for delivering data between a plurality of control units using one memory unit of claim 7, further comprising the step of having said second control unit outputted through an output device, the output device being coupled with said processed raw data.

9. The method for delivering data between a plurality of control units using one memory unit of claim 7, wherein said step (f) is followed by the steps of:
said second control unit determining whether said second control unit has completed reading raw data, the raw data having been written in said first partitioned storage area; and
said second control unit terminating the access to said first partitioned storage area if said second control unit has completed reading said raw data.

10. The method for delivering data between a plurality of control units using one memory unit of claim 7, wherein said step (d) comprises the steps of:
said first control unit determining whether the storage space of said first partitioned storage area is used up;
if used up, said first control unit terminating access to said first partitioned storage area;
said memory unit generating said third access status information and delivering to said first control unit and said second control unit, said third access status information comprising information indicating that said first partitioned storage area is accessible and information on whether said second partitioned storage area is accessible;
said first control unit accessing said second partitioned storage area through said BUS1 and writing said raw data continuously if it is determined by referencing said third access status information that said second storage area is accessible; and
said memory unit generating fifth access status information and delivering the fifth access status information to said second control unit, the fifth access status information indicating that said second partitioned storage area is accessed by said first control unit.

11. The method for delivering data between a plurality of control units using one memory unit of claim 10, wherein said step (f) is followed by the steps of:
said second control unit determining whether said second control unit has completed reading raw data, the raw data having been written in said first partitioned storage area;
said second control unit terminating access to said first partitioned storage area if said second control unit has completed reading said raw data;
said memory unit delivering sixth access status information to said first control unit, the sixth access status information indicating that said first partitioned storage area is accessible;
said second control unit determining whether seventh access status information is received from said memory unit, the seventh access status information indicating that said second partitioned storage area is accessible; and
said second control unit accessing said second partitioned storage area and reading said raw data continuously if said seventh access status information is received.
